(19) United States
(12) Patent Application Publication
(10) Pub. No.: US 2011/0167381 A1
(43) Pub. Date: Jul. 7, 2011

(54) Contextual Document Map

(76) Inventor: Rocky Kahn, Alameda, CA (US)

(21) Appl. No.: 12/983,652

(22) Filed: Jan. 3, 2011

Related U.S. Application Data
(60) Provisional application No. 61/293,168, filed on Jan. 7, 2010.

(51) Int. Cl. G06F 3/048

(52) U.S. Cl. 715/786; 715/784

(57) ABSTRACT

Techniques are described for providing a document map of structure elements (e.g. headings) when a user interacts with a scroll control in a document window. Embodiments provide means of selective pruning (with optional folding/unfolding), differential emphasis, varying line spacing, and/or zooming of structure elements such as when there is insufficient space to display them all. Embodiments provide that document map may be updated dynamically or at conclusion of scroll event.

### CROSS-REFERENCE TO RELATED APPLICATIONS

This application claims the benefit of U.S. provisional application 61293168 “Contextual Document Map”, filed on Jan. 7, 2010.

### BACKGROUND OF THE INVENTION

1. Field

This invention relates generally to providing navigation aids while browsing a document via a computer interface, specifically to extending the functionality of a scroll bar.

2. Prior Art

When browsing a complex document containing structure elements 34 such as headings, some systems provide a table of contents with active links allowing a user to jump to an arbitrary structure element 34. However, the table of contents is typically presented at a fixed location in the document (e.g. at the beginning) which requires the user to scroll there before jumping to a heading. Alternatively, the table of contents may be presented in a separate user interface panel, which occupies significant screen real estate. In either of these approaches, users may not easily jump to a position between structure elements 34 or judge the relative sizes of sections (the size of intervening document content 108) from the table of contents display.

Advantages

Accordingly, several advantages of one or more aspects of the invention are displaying structure elements 34 to a user without requiring the user to scroll to a fixed location in the document or unnecessarily occupying screen real estate. Additionally, user may easily judge relative sizes of intervening document content 108 between structure elements 34 and navigate to intermediate positions between the structure elements 34.

Further advantages will become apparent from a consideration of the ensuing description and the accompanying drawings.

### SUMMARY

In accordance with the invention, the following aspects are described: An embodiment of the present invention provides means for displaying a document map 28 upon a user interaction 104 with a scroll control 22. An embodiment specifies that the document map 28 represents structure elements 34 in a document. An embodiment allows for selective pruning 114 of the structure elements 34 to show those deemed more important in a given context, where importance may be headings closer to the document root or headings above sections with greater amounts of intervening document content 108. An embodiment to reveal structure elements 34 which have been hidden by the selective pruning 114. An embodiment which uses variable emphasis and/or varying indentations 126 to indicate a structure element 34 hierarchy. An embodiment triggering user interaction 104 upon mouse hover event 106 and/or document map 28 is overlaid upon visible document contents 24. An embodiment where document map 28 is centered around scroll bar slider 32, where scrolling dynamically recenters document map 28 upon scroll, where document map 28 recentered upon scroll termination (such as mouseup event 134), and where update is by means of scrollpane mode 136. An embodiment where structure elements 34 are rendered with fixed line spacing or with spacing proportional to intervening document content 108. An embodiment with a zoom range indication, optionally represented by boundary lines 62, and hidden when entire document map 28 shown. An embodiment where clicking on document map 28 structure elements 34 navigates to corresponding structure element 34 in complete document contents 102 and clicking outside document map 28 dismisses it.

### DRAWINGS

The present invention is illustrated by way of example, and not by way of limitation, in the figures of the accompanying drawings and in which like reference numerals refer to similar elements and in which:

FIG. 1 illustrates a document window 20 with scroll control 22.

FIG. 2 illustrates a document window 20 with expanded scroll control 22 revealing a document map 28 with spacing between structure elements 34 proportional to the size of the intervening document content 108 and a visual indication of a zoom range of the document map 58 in the form of a document map bar 60.

FIG. 3 illustrates a document window 20 with expanded scroll control 22 revealing a document map 28 with spacing between structure elements 34 proportional to the size of the intervening document content 108 and a visual indication of a zoom range of the document map 58 in the form of a boundary lines 62.

FIG. 4 illustrates a document window 20 with expanded scroll control 22 revealing a document map 28 whose structure elements 34 indicate larger amounts of intervening document content 108 with larger font size 64.

FIG. 5 illustrates a document window 20 with expanded scroll control 22 revealing a document map 28 with selective pruning 114 to hide structure elements 34 with less intervening document content 108.

### DETAILED DESCRIPTION

Document Map 28

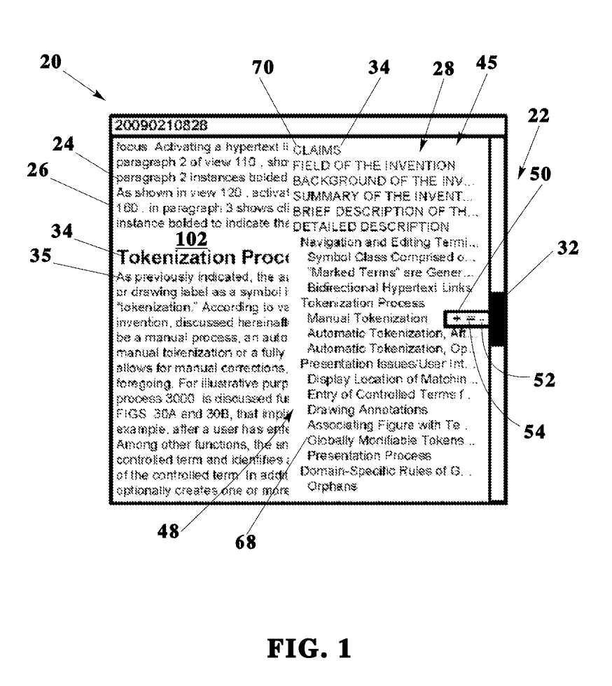

FIG. 1 describes a document window 20 with a scroll control 22 to right of visible document contents 24. Visible document contents 24 includes some or all of the complete document contents 102. The window border 26 surrounds the visible document contents 24 and scroll control 22.

The complete document contents 102 may consist of a series of elements, possibly nested, including structure elements 34 and non-structure elements 35. The complete document contents 102 may consist of any document which has an identifiable flow path (needed for scroll control 22), allowing a single scroll control 22 to be applicable.

If the complete document contents 102 consists of an HTML document, structure elements 34 may include heading elements such as <h1> & <h2>. Depending on the document type, other features may also be considered structure elements 34. In a patent application, for example, short, all-capitalized paragraphs such as “BRIEF DESCRIPTION OF THE DRAWINGS” may be considered structure elements 34. Non-structure elements 35 may include all content which is not interpreted as structure elements 34 such as <p> elements.

If the complete document contents 102 is instead a musical composition, the structure element 34 may include movement indications, dynamics (e.g. “pp” for pianissimo), and repetition/coda markings.

A user initiates a user interaction 104 which may consist of a mouse hover event 106 over a scroll bar slider 32. Thereupon, a document map 28 is overlaid upon visible document contents 24.

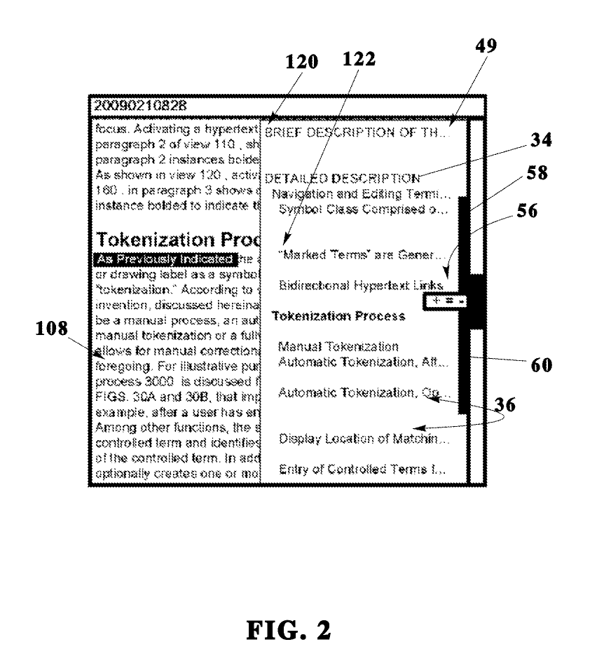

The document map 28 expresses the structure elements 34 of a portion of or the entirety of the complete document contents 102. As shown in FIG. 2, the spacing between structure elements 34 displayed in the document map 28 (inter-element spacing 36) may be proportional to the size of the intervening document content 108 (proportional spacing mode 49). The intervening document content 108 may be considered the structure elements 34 and non-structure elements 35 between any two structure elements 34 displayed in the document map 28. In some situations, the size of intervening document content 108 may be considered its vertical height in the document window 20 compared to the vertical height of the complete document contents 102 in the document window 20.

If complete document contents 102 is shown in document window 20, the position of displayed structure elements 34 in document map 28 and position of structure elements 34 in visible document contents 24 may be coincident at a “Show All” document map magnification ratio 110.

Selective Pruning

The document map 28 may be subjected to selective pruning 114 so that only some structure elements 34 are displayed in the document map 28. Selective pruning 114 may be triggered when structure elements 34 in document map 28 would otherwise overlap (structure element overlap 118).

Selective pruning 114 may, for example, include hiding higher level headings 120 which would otherwise overlap with lower level headings 122 (e.g. <h2> and <h1>, respectively).

Selective pruning 114 may include hiding headings with smaller child content 124. A given heading's child content 124 may be considered the structure elements 34 and non-structure elements 35 following the given heading until another heading of equal or greater importance is encountered. The size of child content 124 may be determined similarly to that of the size of the intervening document content 108.

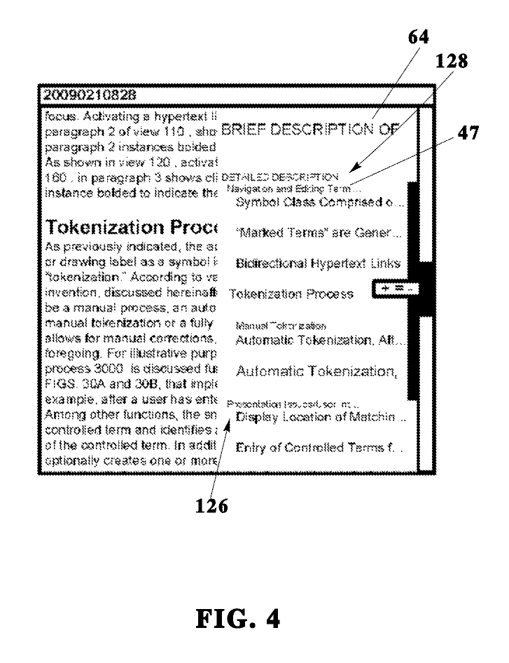

As shown in FIG. 4, structure elements 34 with larger amounts of intervening document content 108 may be rendered with greater emphasis (e.g. a larger font size 64) while structure elements 34 with smaller amounts of intervening document content 108 may be rendered at a smaller font size 47.

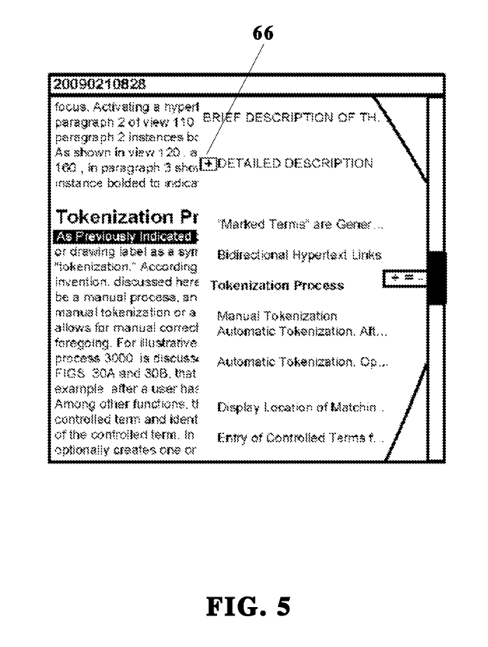

As shown in FIG. 5, structure elements 34 which would otherwise overlap in document map 28 may be rendered so that structure element 34 closest to document root (e.g. smallest heading level) is provided with control to expand and show child structure elements 34 (e.g. larger heading levels). This control may operate, for example by clicking on an plus-expand button 66 or the structure element 34 may be styled to indicate that some user action can be performed upon it (e.g. clicking or dragging it downward) to reveal hidden child structure elements 34.

Document Map 28 Levels

The document map 28 may be formatted to express the structure element hierarchy 48 by, for example, showing structure elements 34 with varying indentations 126 or varying character formatting emphasis 128. For example, <h2> structure elements 34 may be shown with greater indentation 68 or in smaller/less emphasized font size while <h1> structure elements 34 may be shown with lesser indentation 70 or in larger/more emphasized font size.

Positioning of Document Map 28 Elements Relative to Document Window 20

At a “Show All” document map magnification ratio 110, the document map 28 includes all structure elements 34 in the complete document contents 102 except those hidden by selective pruning 114. At this “Show All” document map magnification ratio 110, dragging a scroll bar slider 32 to a structure elements 34 in the document map 28 will scroll document window 20 to corresponding structure elements 34 in complete document contents 102.

At a higher document map magnification ratio 110, document map 28 shows a subset of structure elements 34 in complete document contents 102 approximately centered around position of scroll bar slider 32 in complete document contents 102. For example, as shown in FIG. 2, if document map magnification ratio 110 is set higher, say to 2:1 and scroll bar slider 32 is at mid-position in scroll control 22, only those structure elements 34 appearing in middle half of complete document contents 102 will be included in document map 28.

Repositioning scroll bar slider 32 will cause document map 28 to update such that structure elements 34 displayed therein remain approximately centered around position of scroll bar slider 32 in complete document contents 102.

Table of Contents Mode 45

It may be desirable to provide a table of contents mode 45 whereby document map 28 displays document map 28 with consistent and minimal inter-element spacing 36. As shown in FIG. 1, in this mode, if there are more structure elements 34 than can be represented in document window 20, repositioning scroll bar slider 32 may cause structure elements 34 to flow into the document map 28 from the direction in which the user moves the scroll bar slider 32 and flow off of the document map 28 from the other side.

Static or Dynamic Document Map 28 Update

Document map 28 may be updated statically, say upon termination of user interaction 132 (e.g. mouseup event 134), or dynamically as user repositions scroll bar slider 32.

If document map 28 is updated dynamically as user repositions scroll bar slider 32, behavior is similar to that of Dojox ScrollPane widget (described at http://docs.dojocampus.org/dojox/layout/ScrollPane) (“scrollpane mode 136”). If document map 28 rendered with inter-element spacing 36 proportional to size of intervening document content 108 and document map 28, continuous velocity movement of scroll bar slider 32 will cause continuous velocity flow of structure elements 34 through document map 28. If document map 28 presented in table of contents mode 45, continuous velocity movement of scroll bar slider 32 may cause discontinuous velocity flow of structure elements 34 through document map 28 where discontinuities are due to varying sizes of intervening document content 108.

Click to Jump

When document map 28 is visible, system may be designed to allow user to click on displayed structure elements 34 and thereby scroll document window 20 to its corresponding location.

The document map 28 may be dismissed by the user by, for example, clicking into the visible document contents 24 which are not covered by the document map 28.

If there is a selection range (whether collapsed or non-collapsed) in the complete document contents 102, the document map 28 may indicate

Document Map Magnification Ratio 138

Means to control document map magnification ratio 110 may be provided. A preferred means includes a zoom-in button 50, zoom-out button 52, and zoom-to-fit button 54 (collectively “magnification controls 56”), all controls appearing only when document map 28 is displayed.

Pressing zoom-to-fit button 54 causes complete range of structure elements 34 to be rendered in document map 28. Note that selective pruning 114 may cause some of these structure elements 34 to be hidden. Subsequently pressing zoom-in button 50 causes range of structure elements 34 that can be shown in document map 28 to be restricted, say to those which appear in the half of the complete document contents 102 centered around the current position of the scroll bar slider 32 in the scroll control 22 (though limited by the scroll control 22 boundaries). Pressing zoom-in button 50 again, further restricts range. Pressing zoom-out button 52 increases range.

When document map 28 is zoomed in (i.e. visible structure elements 34 in document map 28 span only a portion of complete document contents 102), it may be desirable to show what portion of the complete document contents 102 are represented by the document map 28 (“visual indication of a zoom range of the document map 58”).

This may preferably be expressed as a document map bar 60 to side of scroll control 22 or document map 28. The visual indication of the zoom range of the document map 58 shortens as document map magnification ratio 110 is increased (zoom-in button 50) and lengthens as document map magnification ratio 110 is decreased (zoom-out button 52). The visual indication of a zoom range of the document map 58 may be approximately centered around scroll bar slider 32 (though limited by scroll control 22 boundaries).

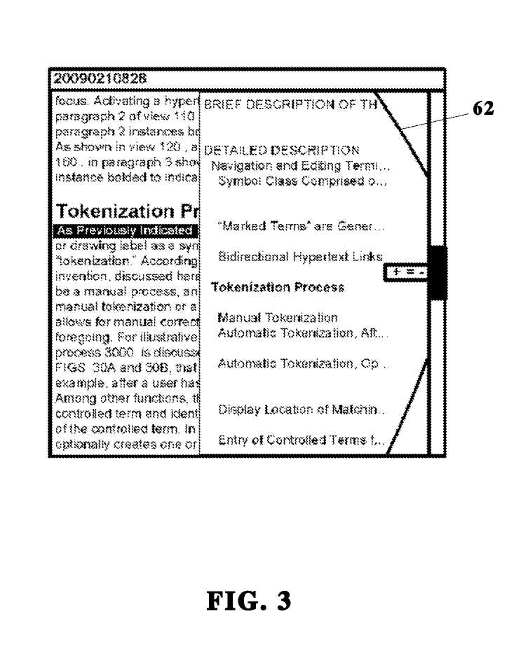

Alternatively, visual indication of a zoom range of the document map 58 may instead be expressed by boundary lines 62 as shown in FIG. 3 which reach from extents of document map 28 to extents on scroll control 22.

When the complete document contents 102 are represented by the document map 28 (e.g. when user presses the zoom-to-fit button 54), the visual indication of a zoom range of the document map 58 may be hidden.

1. A method comprising: displaying a document map upon a user interaction with a scroll control in a document window

2. The method of claim 1, where the document map represents structure elements in a document

3. The method of claim 2, where the document map is processed with a selective pruning to reduce a structure element overlap

4. The method of claim 3, where the selective pruning removes a subset of the structure elements farther from document root which would otherwise overlap with the structure elements closer to document root.

5. The method of claim 4, where said structure elements closer to document root are provided with control to reveal hidden structure elements farther from document root.

6. The method of claim 3, where the selective pruning renders with less emphasis the structure elements that possess smaller amounts of intervening document content

7. The method of claim 3, where the selective pruning hides the structure elements with smaller amounts of intervening content in order to reduce structure element overlap

8. The method of claim 2, where the document map renders the structure elements with varying indentations to indicate a structure element hierarchy

9. The method of claim 2, where the document map renders the structure elements with varying character formatting emphasis to indicate a structure element hierarchy

10. The method of claim 1, where the user interaction is a mouse hover event

11. The method of claim 1, where the document map is overlaid upon visible document contents of the document window

12. The method of claim 1, where the document map is approximately centered around position of a scroll bar slider in a complete document contents

13. The method of claim 12, where repositioning the scroll bar slider causes the document map to update such that structure elements displayed in the document map remain approximately centered around position of the scroll bar slider in the complete document contents

14. The method of claim 13, where the document map is updated upon a termination of user interaction

15. The method of claim 14, where the termination of user interaction is mouseup event

16. The method of claim 13, where the document map is updated dynamically as user repositions the scroll bar slider

17. The method of claim 16, where the document map may be navigated by means of a scrollpane mode.

18. The method of claim 12, where the document map is rendered with inter-element spacing proportional to a size of intervening document content

19. The method of claim 18, where the size of intervening document content is determined as its length in the document window compared to length of the complete document contents in the document window.

20. The method of claim 18, including means to control a document map magnification ratio such that range of structure elements that can be shown in the document map to be controlled.

21. The method of claim 20, where magnification controls are displayed when the document map visible

22. The method of claim 20, including a visual indication of a zoom range of the document map.

23. The method of claim 22, where the visual indication of the zoom range of the document map is provided by a document map bar adjacent to the scroll bar slider where the document map bar's length is proportional to ratio of that portion of the complete document contents which is represented by the document map divided by a size of complete document contents.

24. The method of claim 22, where the visual indication of the zoom range of the document map is provided by boundary lines which reach from extents of the document map to extents on the scroll control represented by the document map

25. The method of claim 22, where the visual indication of the zoom range of the document map is hidden when the complete document contents are represented by the document map

26. The method of claim 12, where the document map is rendered with consistent inter-element spacing

27. The method of claim 1, where clicking on one of displayed structure elements in the document map causes the document window to scroll to corresponding location in complete document contents.

28. The method of claim 27, where the user interaction outside the scroll control and the document map dismisses the document map
